(19) United States
(12) Patent Application Publication
(10) Pub. No.: US 2008/0246597 A1
(43) Pub. Date: Oct. 9, 2008

(54) METHOD, SYSTEM, AND APPARATUS FOR PROVIDING AN EVENT REMINDER

(76) Inventors: Charles Carlson, Olathe, KS (US); Christopher Somercik, Plymouth, MI (US); Randall Somercik, Maple Grove, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/062,234

(22) Filed: Apr. 3, 2008

Related U.S. Application Data
(60) Provisional application No. 60/910,518, filed on Apr. 6, 2007.

(51) Int. Cl. G08B 23/00

(52) U.S. Cl. 340/500

(57) ABSTRACT

A product event timer for use with a consumer product is provided that includes a housing; timer circuitry incorporated with the housing, which includes a countdown timer; and a sensory signal coupled to the timer circuitry and activated upon receiving an activation signal from the timer circuitry; where a user is signaled to interact with the consumer product upon activation of the sensory signal.

### CROSS REFERENCE TO RELATED APPLICATION

This application claims benefit under 35 U.S.C. § 119(e) to U.S. Ser. No. 60/910,518, entitled “Method, System, and Apparatus for Providing an Event Reminder”, filed Apr. 6, 2007 (attorney docket number 189161/US), the content of which is incorporated herein by reference in its entirety.

### FIELD OF THE INVENTION

The present invention provides a system, method, and/or apparatus for reminding a user to take action at a specified time interval. In one embodiment, the present invention provides a product event timer (“PET”) for accompanying products that remind end users to take action at a specified interval.

### BACKGROUND OF THE INVENTION

Timers are commonly used for timing events that occur over a short-term basis. Stop watches are timers that are used, for example, to time races that may occur over a series of seconds, minutes or hours. Typically, stop watches count upwards from zero seconds up to a point when a user presses a stop button. Kitchen timers are used as a reminder for signaling when an item should be removed from a heat source such as a stove or an oven. Typically, kitchen timers count down from twelve hours or less. Alarm clocks are timers that may be used daily as a wake-up signal and typically will provide an alarm at the same time every day, e.g., every twenty-four hours. However, if a single alarm is to be set, the alarm clock is required to be set within a twenty-four hour time period before the alarm is to activate. However, none of the timers described provide a timer that is useful for providing signals after a specified interval, where the time interval associated with the timer is associated with a specified product. Accordingly, there is a need to provide an event timer that has the flexibility to be used with a variety products.

### SUMMARY

The present invention addresses the issues identified above by providing a product event timer that provides a user with a signal to interact with a consumer product.

According to one embodiment, a product event timer is configured for use with a consumer product. The PET includes a housing, timer circuitry incorporated with the housing, the timer circuitry comprising a countdown timer, and a sensory signal coupled to the timer circuitry and activated upon receiving an activation signal from the timer circuitry, where a user is signaled to interact with the consumer product upon activation of the sensory signal.

According to another embodiment a product event timer is configured for use with a consumer product and includes a housing, a power source coupled to the housing, timer circuitry conditionally coupled to the power source, alarm circuitry coupled to the power source and to the timer circuitry, the alarm is circuitry configured to initiate an alarm signal capable of being sensed by a user, and an actuator for initiating or terminating the alarm, once the power source is initially coupled to the power source, the alarm signal is initiated, and upon the user actuating the actuator, the alarm signal is turned off and the alarm circuitry initiates the timer circuitry.

These and other features and advantages of the present invention will become apparent to those skilled in the art from the following detailed description, wherein it is shown and described illustrative implementations of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWING

FIG. 1 depicts an exemplary schematic of a product event timer in accordance with some embodiments.

FIG. 2 depicts a front view of a product event timer arranged in a holding structure in accordance with one embodiment.

FIG. 3 depicts a side view of the embodiment of FIG. 2.

FIG. 4 depicts a front view of a product event timer maintained in a holding structure in accordance with one embodiment.

FIG. 5 depicts a side view of the embodiment of FIG. 4.

FIG. 6 depicts a front view of a product event timer maintained in a holding structure in accordance with one embodiment.

FIG. 7 depicts a front view of a product event timer maintained in a holding structure in accordance with one embodiment.

### DETAILED DESCRIPTION

According to one embodiment, the present invention relates to a system, method, or apparatus for providing an event reminder or a series of such reminders. In one embodiment, a product event timer (PET) is provided for use on or with consumer products that require or remind the user to take an action after a period of time. That is, the PET may be a stand alone device that is packaged with a product or the PET may otherwise be associated with a product, e.g., attached or incorporated into the product, and may be configured to be actuated by the user to subsequently provide a reminder at a predetermined time. The PET may be used once, or multiple times, and may be set and reset. The PET also may have a small size enabling a product manufacturer to attach or embed the PET within the manufacturer's own product, product packaging or to enable it to stand alone.

PET event notification may be accomplished by several different methods or components. In certain embodiments, the PET may be configured with various notification methods including via an optical alarm, audible alarm and/or a vibrating alarm. Suitable notification methods may include audible notification, e.g., beeping, chiming, verbal message, visual notification, such as by a blinking timer or lights, colored lights, changing color indicators, or by illuminating any portion of the PET in order to notify the end user that an action needs to be taken. It is understood that any signal or alarm may be used that is suitable for notifying an end user that action is to or should be taken in relation to the manufactured product associated with the PET.

According to certain embodiments, the notification alarm may be turned off and reset by the end-user or may be automatically turned off and/or reset by a sensor integrated into the PET, which may detect specific user behavior.

The notification attributes of the PET may be standardized and programmed using any suitable programming code during the manufacturing process. PET parameters that may be programmed include a time interval, e.g., the number of days, hours, minutes between the activation/reset of the PET and the next notification alarm, notification reset criteria, e.g., activities that must be performed to reset the interval count to 0 (i.e. number of seconds that the actuator must be depressed), cycle number, e.g., the number of times that the notification alarm may be reset to 0, the cycle count notification, e.g., the method for notifying the user how many times the notification alarm has been reset, blink sequence, e.g., the number, frequency, duration, and/or dormant periods, and other notifications, e.g., other optical, audio, or sensory feedback that may be programmed based upon use or timing of the PET or associated product.

The PET may be used in various applications.

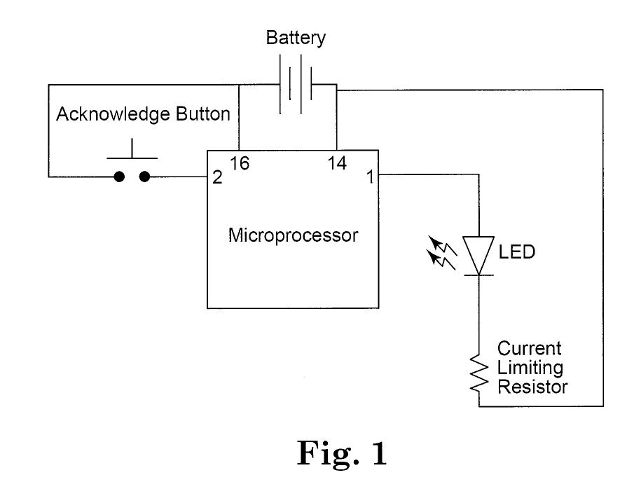

According to one implementation, the PET may be manufactured according to a manufacturer's specifications. For example, a manufacturer may configure a PET according to FIG. 1, in which a microprocessor is provided and is coupled to LED acknowledge button and a battery or other power source. Reference numbers 1, 2, 14 and 16 denote pin numbers on the microprocessor. Such a microprocessor may include the energy efficient TI MSP430 processor series (manufactured by Texas Instruments) or an equivalent processor. The microprocessor may be configured to start a pre-programmed countdown time when activated, for example, by a long push on the acknowledge button. In response, the LED may be configured to flash in order to acknowledge the push and require the user to release and then re-engage the acknowledge button. Upon re-engagement of the acknowledge button, the processor begins counting down the pre-programmed time. Once the count down period is completed, the LED may flash indicating the time period has elapsed. Once the user presses the acknowledge button, the LED may turn off and the time sequence may start over. In addition, the microprocessor, according to certain embodiments may include a sleep mode capacity.

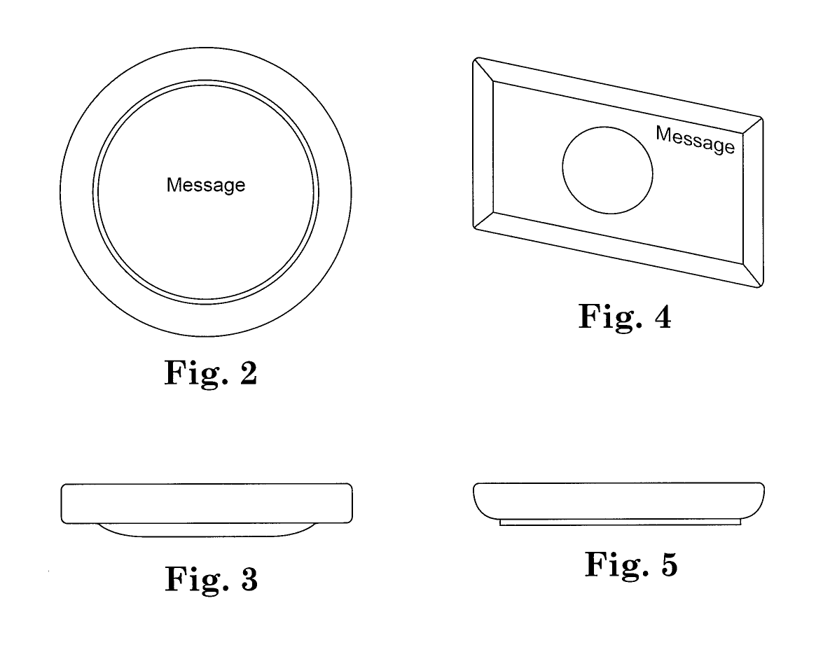

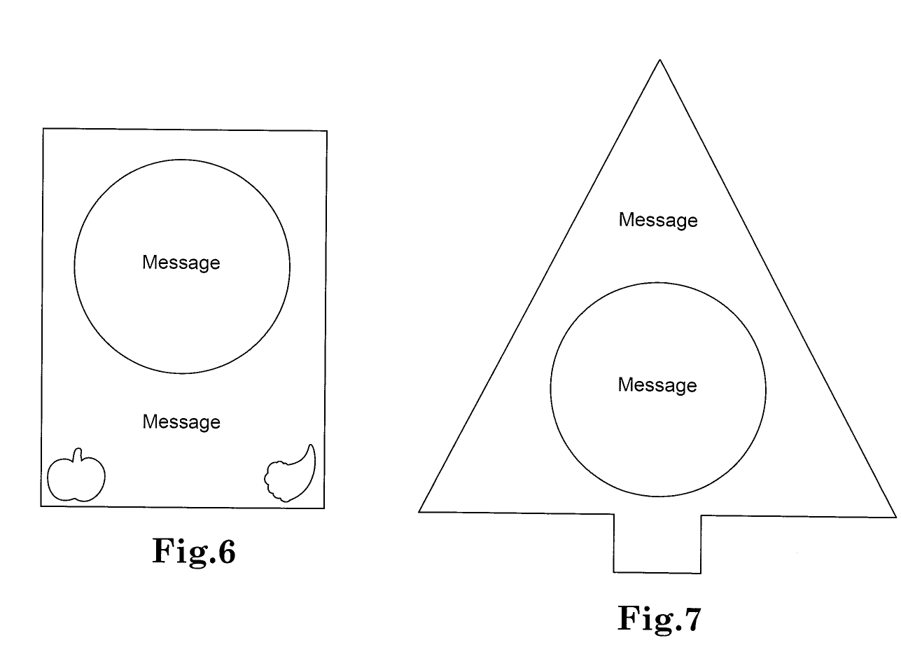

In some implementations, the PET circuitry may be encased in various products and/or forms or associated with such products. In some embodiments, the PET may be held in a holding structure, which is sized and shaped to accommodate the PET on or in the holding structure. For example, the holding structure may have a complementary shape to the PET and the PET may be maintained in the holding structure through friction fitting or a snap fitting into a ridge or groove of the holding structure. In some embodiments, the holding structure may cover a portion of the external surface of the PET. For example, the holding structure may comprise a sleeve with elastic properties, e.g., a polyurethane sleeve, which surrounds all or a portion of the external surface of the PET (FIGS. 2-3). In another example, a portion of the PET displaying the countdown timer and/or a button may be visible and/or accessible through an opening, e.g., window, in the holding structure, while all or a portion of the remainder of the PET is encased in the holding structure (FIGS. 4-7). In another example, the PET circuitry may be encased in or on a pet tag, which may be similar in shape and size of most animal license tags and which may have the necessary clasp to be easily attached to most pet collars. Alternatively, a companion or noncompanion animal tag may be configured in a shape and size suitable for the animal. For example, a tag used on cattle may be configured so that it attaches to an ear or a preexisting ear tag, whereas for a dog, the tag may be configured to attach to a dog collar. PET circuitry may be encased in or on a refrigerator magnet, which may include the PET by itself or may be incorporated as a part of an advertising or logo article. In addition, the PET may include the logo of the manufacturer in or on the PET. In some embodiments, an encasing or holding structure may be provided with a written message, such as for example a slogan, logo, written message or instruction, on its external surface. For example, the external surface of the PET holder or encasing may be embossed with a phone number or other information related to the product associated with the PET. In certain implementations, PET circuitry may be incorporated with miscellaneous logo configurations where the PET may stand alone or in combination with another advertising logo item such as a pen, pin, cup, medallion, calendar, desk ornament, paper weight, sticker, ring, and the like.

PET may be included in or otherwise be associated with product packaging when the product functionality is changed upon user interaction with the product. PET may also be included in product packaging when the product has an expiration date. In some implementations, the PET may be distributed separate from the product packaging. For example, a cashier, veterinarian or service technician may distribute a PET when providing a product to an end user. In some embodiments, a PET configured to provide a notification alarm after a predetermined time may be distributed to users. Once the notification alarm is triggered, the triggered alarm reminds the user to visit a certain retailer, restaurant, or service provider, for example. In a further embodiment, PET may be used in conjunction with a promotional discount. For example, a retailer, restaurant, or service provider may provide a user with a PET configured to provide a notification alarm, such as for example a blinking LED, for a predefined period of time. If the user arrives at a specified location during the alarm period, such as a promotion host store, the user may receive a promotional discount.

The PET may be designed for use in combination with companion or noncompanion animal products, furnace filters, plant care products, etc. For purposes of this application, “animal products” is intended to encompass any product that can be used in the maintenance or care of an animal. In addition, the PET may be incorporated into any logo item for general applications. Alternatively, the PET can be used with any item in which an event reminder is useful.

The PET may be used according to various methods. According to one example, once the PET reaches an end user, the user may remove a battery pull tab to cause the PET to engage, thereby triggering a timer that provides a notification alarm after a predetermined period. The user may perform the action in response to instructions provided in a user manual or product manual, such as a manual associated with administering a pet medication, for attaching a flea collar, applying ointments, changing furnace filters, taking care of plants, or any other known product or user manual for which an event reminder may be useful.

Once the notification alarm is triggered after the designated interval counts down to 0, for example, the triggered alarm notifies the user to take the next action suggested by the packaging instructions. For example, the user may administer a next dose of medication or may replace a flea/tick collar with a new one. Further, the user may push a button on the PET to turn off the notification alarm and the PET may automatically reset the alarm or the user may choose when to reset the alarm. According to some implementations, the PET is configured with a delay function so that if the user is unavailable to perform the prompted task, the user may select to delay the notification for a predetermined period of time, e.g., 5 minutes, 1 hour, 1 day to 5 days, 1 week, etc., or for a user-selected period of time, e.g., in which the user selects when the alarm is to sound again.

According to some configurations, the device can also be configured to provide information about the number of times the alarm has been triggered and/or the number of times the alarm has been reset, such as, for example, by actuating a particular button or some other method. According to some embodiments, the device can be configured for variable alarm sequences, such as for example a series of blinks and/or beeps, having a predetermined frequency and duration. For example, the device may be configured for a first reminder alarm sequence having beeps at a frequency of 1 per second for 1 minute and a second reminder alarm sequence having a frequency of 2 per second for 2 minutes. Alternatively, alarm sequences having any frequency and/or duration may be employed.

In some configurations, the PET is configured with a single button, which can trigger multiple functions based on the duration of time or number of times the button is selected. For example, the timer may blink after the timer reaches 0, and the user selects the button until the timer is solid. Subsequently, the user may select the button for a longer period in order to reset the timer. In alternative configurations, the PET is configured with multiple buttons, each of which may have one or multiple functions.

According to one implementation, the PET may also provide an additional message or additional information in conjunction with the alarm, the alarm reset, or at the end of the life cycle of the associated product. In some embodiments, the PET may be configured with a display which may communicate the time remaining for a particular cycle or message, for example. In additional embodiments, a message or information may be a marketing message, reordering instructions or other audible or visible message.

In one embodiment, once the product associated with the PET is no longer of use, is expired, or is used up, the PET may be disposed of.

According to certain implementations of the present invention, the PET may be included with flea, tick or other companion or noncompanion animal medications, foods and vitamins sold in multi-dose or multi-use packages. For example, a companion or noncompanion animal owner may attach the PET to an animal's collar or may place it in a prominent place such as by a calendar or on the refrigerator. The owner can then apply the medication and push the button on the PET to activate the timer and thereby set the device to trigger the alarm in the predefined number of days. Subsequently, when the owner notices that the PET is illuminated or the alarm has otherwise been triggered, the owner may be reminded to give the companion or noncompanion animal the next dose of medication. In an alternative embodiment, the PET may be included with human medications, foods, vitamins, and the like.

According to another implementation, the PET may be sold with flea and tick collars that have a limited duration of effectiveness. For example, the PET may be secured to the flea/tick collar or be provided in a form to allow a companion or noncompanion animal owner to display it in a prominent place. The owner may push the button on the PET to activate the timer and thereby set the device to trigger the alarm in the predefined number of days. Subsequently, when the owner notices that the PET is illuminated, the owner may be reminded to replace the old flea/tick collar with a new one.

The PET may also be used in combination with furnace filters and may be provided in or with packaging for the furnace filters, or which may be available at retail outlets or provided by service companies. The furnace owner may place the PET in a prominent place such as on the refrigerator or on or by a thermostat. Upon installation of a new furnace filter, the owner may push the button on the PET to activate the time and thereby set the device to trigger the alarm in the predefined number of days. When the owner notices that the PET is illuminated, the owner may be reminded to change the filter. Additionally, the owner may be provided with a message to perform any other equipment maintenance and/or be provided with any information related to furnace maintenance, such as for example, service provider contact information. In some embodiments, messages may be provided to a user as an audio message and/or as a digital message displayed on the PET. Alternatively, the message may be provided on the external surface of the PET.

Furthermore, the PET may be incorporated into any number of company logo items and may be used for a variety of reminders or to deliver a specific marketing message at a predetermined interval.

The PET may be provided with various functions, capabilities and configurations, and may be combined with, in or on various consumer products. The products are not required to be of one type, e.g., perishable, and the products may, in certain circumstances, require a PET, and in other circumstances, not require a PET in order to properly function.

According to certain implementations, the PET of the present invention may be provided with functions or capabilities provided in U.S. Pat. Nos. 5,495,961; 5,602,802; 5,623,242; 5,805,051; 6,075,755; 6,314,384; 6,335,907; 6,421,650; 6,665,966; 6,934,220; and 6,985,869, which are herein incorporated by reference in their entireties.

From the above description and drawings, it will be understood by those of ordinary skill in the art that the particular implementations shown and described are for purposes of illustration only and are not intended to limit the scope of the present invention. Those of ordinary skill in the art will recognize that the present invention may be embodied in other specific forms without departing from its spirit or essential characteristics. References to details of particular implementations are not intended to limit the scope of the invention.

What is claimed is:

1. A product event timer configured for use with a consumer product, comprising:
a housing;
timer circuitry incorporated with the housing, the timer circuitry comprising a countdown timer; and
a sensory signal coupled to the timer circuitry and activated upon receiving an activation signal from the timer circuitry;
wherein a user is signaled to interact with the consumer product upon activation of the sensory signal.

2. The product event timer of claim 1, wherein the timer circuitry is pre-programmed to a specified countdown duration.

3. The product event timer of claim 1, wherein the timer circuitry is programmed by the user.

4. The product event timer of claim 1, wherein the timer circuitry is programmed by a distributor of the product associated with the product event timer.

5. The product event timer of claim 1, wherein the sensory signal is at least one of an audible, visual or tactile signal.

6. The product event timer of claim 1, wherein the housing is the consumer product.

7. The product event timer of claim 1, wherein the housing is disposed on a packaging for the consumer product associated with the product event timer.

8. The product event timer of claim 1, wherein the housing is distributed separately from the consumer product associated with the product event timer.

9. The product event time of claim 1, wherein the consumer product comprises an animal product.

10. A product event timer configured for use with a consumer product, comprising:
a housing;
a power source coupled to the housing;
timer circuitry coupled to the power source;
alarm circuitry coupled to the power source and to the timer circuitry, said alarm circuitry configured to initiate an alarm signal capable of being sensed by a user;
an actuator for initiating or terminating the alarm;
wherein at least one of the timer circuitry and alarm circuitry is conditionally coupled to the power source;
wherein when the power source is initially coupled to the power source, the alarm signal is initiated, and upon the user actuating the actuator, the alarm signal is turned off and the alarm circuitry initiates the timer circuitry.

11. The product event timer of claim 10, wherein the timer circuitry is configured to countdown using one or more intervals.

12. The product event timer of claim 11, wherein the consumer product is a furnace filter.

13. The product event timer of claim 12, wherein at least one of the one or more intervals corresponds to the useful life of the furnace filter.

14. The product event timer of claim 13, wherein product event timer is further configured to provide a message related to furnace maintenance.

15. The product event timer of claim 14, wherein the message comprises service provider contact information.

16. A method of providing an advertising message comprising:
providing a timer to a user, wherein the timer comprises:
a housing;
timer circuitry incorporated with the housing, the timer circuitry comprising a countdown timer; and
a sensory signal coupled to the timer circuitry and activated upon receiving an activation signal from the timer circuitry;
wherein the timer is configured to provide an advertising message to the user upon activation of the sensory signal.

17. The method of claim 16, wherein the advertising message comprises a message reminding the user to contact one or more retailers, restaurants, and/or service providers.

18. The method of claim 16, wherein the advertising message comprises a message relating to a promotional discount.

19. The method of claim 18, wherein the timer is further configured to provide a notification alarm for a predetermined period upon activation of the sensory signal.

20. The method of claim 18, wherein if the user brings the timer to a predetermined location during the notification alarm period, the user is provided with the promotional discount.
